(19) United States
(12) Patent Application Publication
(10) Pub. No.: US 2011/0210660 A1
(43) Pub. Date: Sep. 1, 2011

(54) LED BULB ASSEMBLIES

(76) Inventor: HSIN-WEI WU, Hsinchu City (TW)

(21) Appl. No.: 12/714,548

(22) Filed: Mar. 1, 2010

(51) Int. Cl. H01J 5/50

(52) U.S. Cl. 313/318.05

(57) ABSTRACT

The present invention is to provide a LED bulb assembly, which includes a LED body and two connecting legs, wherein the LED body made of only one material with a nipple-type appearance. The LED body includes a head and body, in which the head is a semi-ball connecting with side arcs and the body is a cylinder. In use of these, the light will be the true color of the lighting source.

### BACKGROUND OF THE INVENTION

A traditional glass bulb assembly, as shown in FIG. 1, includes a LED body (10) covered with a nipple-typed shell (20), which is capable of being various color for accompanying the color of the LED body (10). Since the said traditional bulb assembly is made of two different materials, the light of lighting source (101) of the LED body (10) will be twisted. Hence, the appearance from the shell (20) is usually not the same as the original that comes to an obviously drawback.

### SUMMARY OF THE INVENTION

The present invention is to provide an improved LED bulb assembly, which includes a same material to form a nipple-type bulb assembly like a prior one. This LED body has a head and a body wherein the head is a semi-ball connecting with arcs and the body is a cylinder, and the lighting source is provided in the body, that provides a true color of light appeared outside the shell and overcomes the drawback of the traditional products. The structures of the present invention will be described hereafter by referring to the following drawings.

### BRIEF DESCRIPTION OF THE DRAWINGS

FIG. 1 is a cross-sectional plan diagram of a traditional LED bulb assembly.

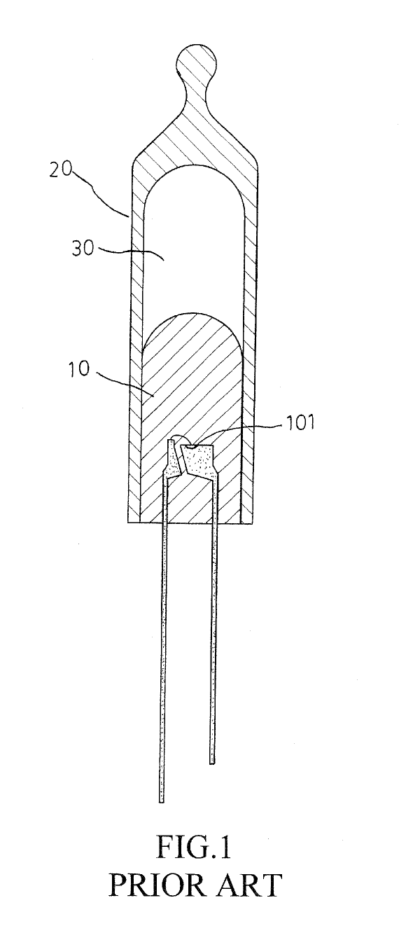

FIG. 2 is an outside appearance diagram of a LED bulb assembly according to the present invention.

FIG. 3 is a cross-sectional plan diagram of FIG. 2.

### DETAILED DESCRIPTION OF THE PREFERRED EMBODIMENT

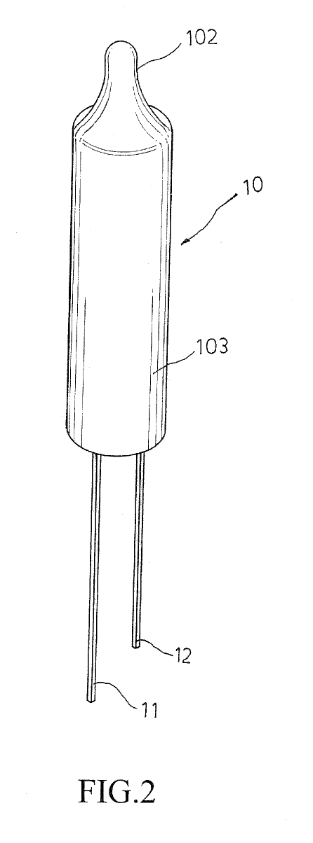

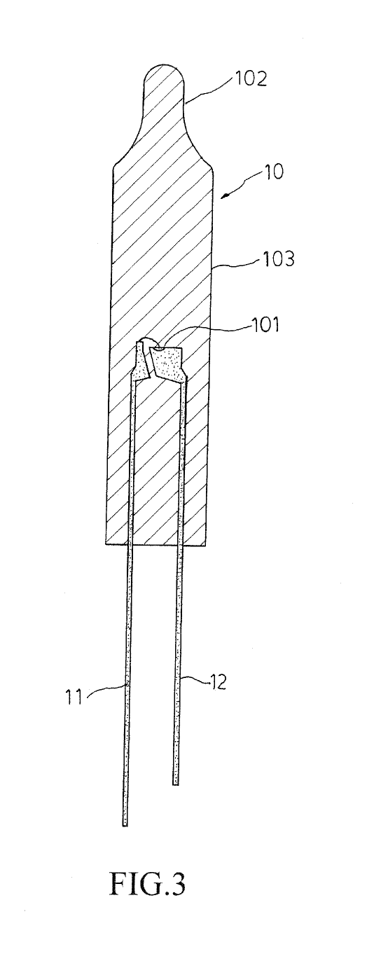

Please refer to FIGS. 2 and 3. The present invention relates to an improvement of the LED bulb assemblies, which includes a LED body (10) made of only one material to become a solid body with a nipple-type appearance. The LED body (10) includes a head (102) and a body (103). The head (102) has a structure formed by a top semi-ball and side arcs. The body (103) is a cylinder, which is about 70 percentage of the bulb assembly at longitude. Two connecting legs (11), (12) have their top ends extended into the body (103) to contact with the lighting source (101) at a position between 50 to 70 percentage high from bottom of the body (103). Through these, as the lighting source (101) is lightened, the light is emitted through the same material of the bulb assembly that shows a true color of the light, whereas the semi-ball top of the head can condense the light smoothly.

Therefore, the present invention obviously is equipped with the conditions of patent act. And it is to be understood that any modified design according to the merit of the present invention will be still claimed in this application.

I claim:

1. A LED bulb assembly including a LED body and two connecting legs, wherein the LED body made of only one material with a nipple-type appearance includes a head and body, in which the head is a semi-ball connecting with side arcs and the body is a cylinder; the two legs having their top ends extended into the body to contact with a lighting source therein.

2. A LED bulb assembly as claimed in claim 1, wherein the body is about 70 percentages at longitude of the bulb assembly.

3. A LED bulb assembly as claimed in claim 1, wherein the lighting source is at a position between 50 to 70 percentage high from bottom of the body.
